(19) United States
(12) Patent Application Publication
(10) Pub. No.: US 2011/0072601 A1
(43) Pub. Date: Mar. 31, 2011

(54) EXTENDABLE DEVICE

(76) Inventors: Craig Serio, New Berlin, WI (US); John Edward Cronin, Jericho, VT (US); Nancy Edwards Cronin, Jericho, VT (US); Sarju Safeek, Dallas, TX (US)

(21) Appl. No.: 12/889,213

(22) Filed: Sep. 23, 2010

Related U.S. Application Data
(60) Provisional application No. 61/245,997, filed on Sep. 25, 2009.

(51) Int. Cl. B25G 1/00; B25G 1/04

(52) U.S. Cl. 15/143.1; 16/429

(57) ABSTRACT

Devices, apparatuses, systems and/or methods related to extendable devices. Specifically, the disclosed devices, apparatuses, systems and/or methods relate to extendable devices having a first handle section, a second handle section, an implement section, an advancement strip. Some example embodiments further include a guide block and a spring to assist in extension and/or retraction of the device. Some example embodiments further include an advancement strip channel to assist in extension and/or retraction of the device.

### CROSS REFERENCE TO RELATED APPLICATIONS

This application claims the benefit of U.S. Provisional Patent Application Ser. No. 61/245,997, entitled “Extendable Device Using a Guide Block and Spring System to Accommodate Accessories such as Paint Rollers,” filed on Sep. 25, 2009, the disclosure of which is incorporated herein by reference.

### BACKGROUND

Painting apparatuses (e.g., paint rollers) are known in which a cylindrical paint brush is fitted on to a roller. The roller is rotatably connected to a handle such that a user can roll the cylindrical paint brush along a wall surface to transfer paint from the paint brush to the wall surface. In the most common design, the handle is only one to two feet long.

In many painting applications, it is necessary for the user to access hard-to-reach locations. For example, with interior painting of walls and the like, a user typically can not reach the ceiling of the room simply with an out-stretched arm and a typical paint roller. Accordingly, ladders and scaffolding are commonly employed in such situations. While effective, they are relatively expensive alternatives, and are relatively difficult to assemble and move about a work site. Furthermore, a dangerous situation can easily arise in which a user leans to far away from the ladder and could possibly tip over and injure him or herself.

Accordingly, it is often the situation that a user will employ an extension device such as an extension pole to which the paint roller can be attached. Such a device is described in U.S. Pat. No. 7,096,530, “Paint Roller With Extendable Handle,” assigned to Newell Operating Company. The described device provides a three-shaft system wherein an advancement strip assists in extending a third shaft of the device, without requiring the user to touch the third shaft. The disclosed design increases the speed of assembly of the device for use, and prevents the user from touching portions of the paint roller that could be wet and messy.

However, the '530 patent does not address other issues that would provide improved operation. For example, the device described in the '530 patent requires the user to “pull” open the device by grasping the handle and the second shaft and pulling them in opposite directions. Users with limited grip and physical strength may find it difficult to open the device prior to use. Once a user initiates opening the device, if it has required undue force, the device may overextend and “fly apart.” This results in the three shafts becoming disengaged from one another. What is needed is a way to provide added force to assist the user in extending the device, and also a way to prevent the device from coming apart should the user pull too hard when initially opening the device.

Further, the '530 patent requires materials and manufacturing to support the design. The moving parts and assembly required increases the overall cost of the device. What is needed is a simplified design that achieves the same operational objectives, at a lower cost of material and manufacturing.

### SUMMARY OF THE DISCLOSURE

This disclosure is drawn to devices, apparatuses, systems and/or methods related to extendable devices. Specifically, the disclosed devices, apparatuses, systems and/or methods relate to accessories that may require extension (e.g., paint rollers) and, more specifically, relates to extension devices.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

In the drawings:

FIG. 1 depicts a simplified cross-sectional view of an extendable device in a retracted position in accordance with an example embodiment of the invention.

FIG. 2 depicts an exemplary cross-section view of a guide block in accordance with an example embodiment of the invention.

FIG. 3 depicts a simplified cross-sectional view of an extendable device in an extended position in accordance with an example embodiment of the invention.

FIG. 4 depicts a simplified cross-sectional view of an extendable device in a retracted position in accordance with another example embodiment of the invention.

FIG. 5 depicts a simplified cross-sectional view of an extendable device in an extended position in accordance with another example embodiment of the invention.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and make part of this disclosure.

In an example embodiment, an extendable handle for a paint applicator that includes a first shaft having a distal end and a proximal end and a second shaft with a distal end and a proximal end and which is telescopically disposed within the first shaft is provided. A guide block and spring is disposed on the first shaft and defines a curved channel. A third shaft has a distal end and a proximal end and is telescopically disposed within the second shaft. An advancement strip has a first end connected to the distal end of the first shaft and a second end connected to the proximal end of the third shaft and is disposed through the curved channel of the guide block. The advancement strip can both push and pull the third shaft relative to the second shaft.

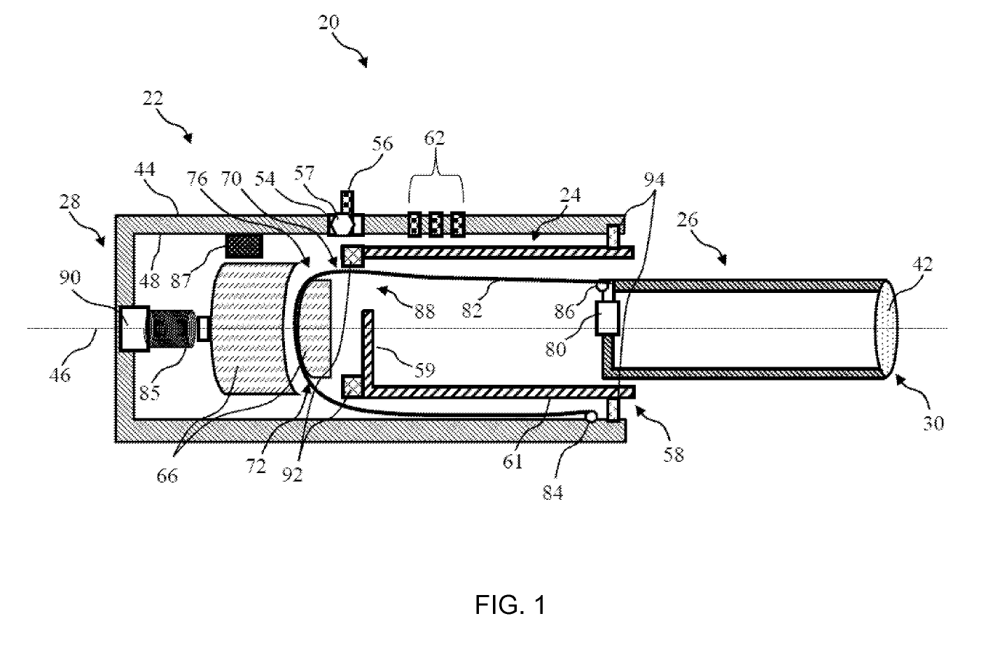

In an example embodiment, as generally depicted in FIG. 1, an extendable device having a guide block with spring system is provided. The spring system may provide an additional thrusting force to assist in opening and extending the shafts with a reduction in pulling force required from the user. Such example embodiment may incorporate one or more “crimps” that prevent the spring force from overextending and disengaging the shafts. A example embodiment of the extendable device is described in reference to FIGS. 1, 2, and 3 below.

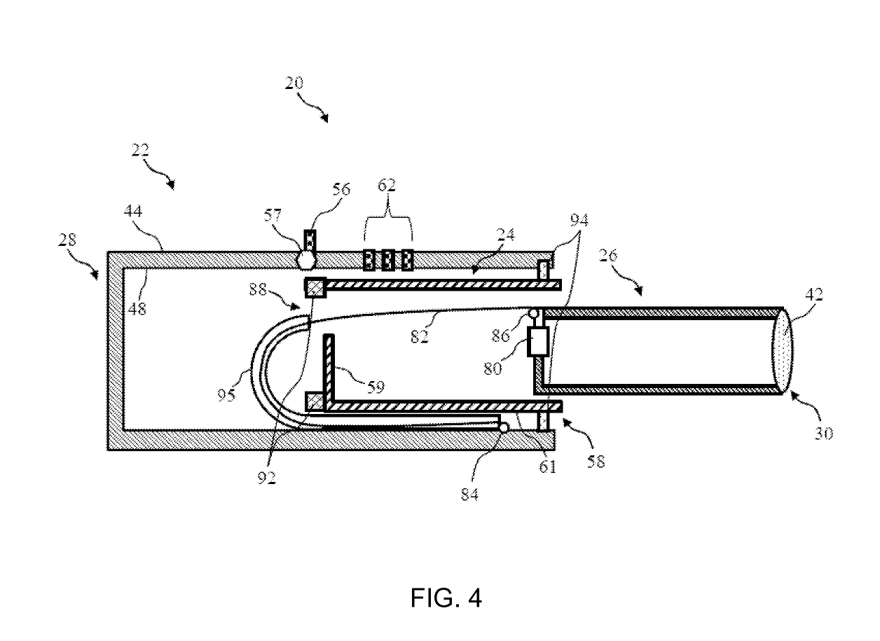

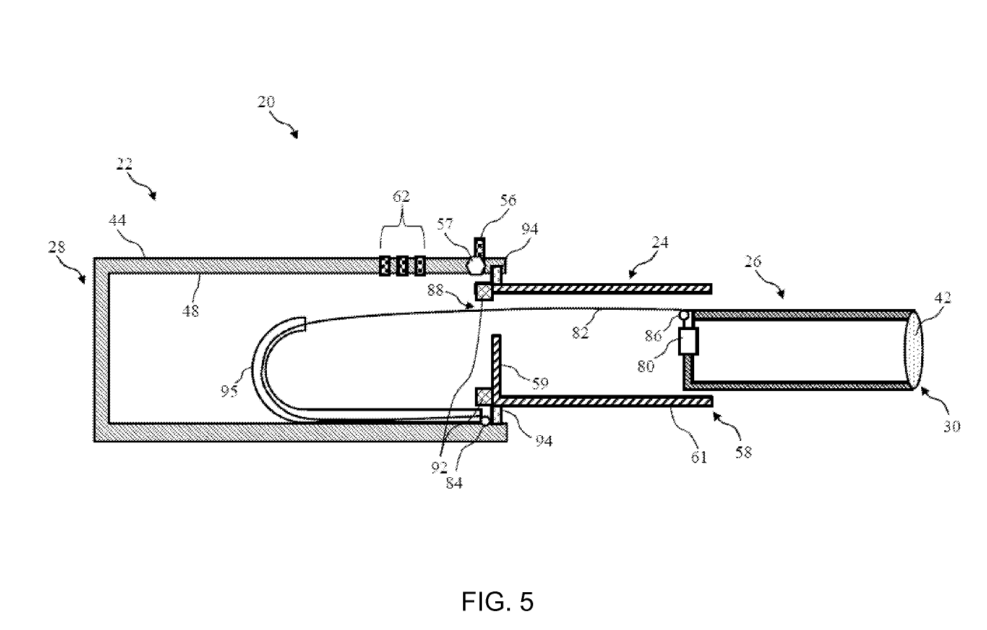

In another example alternate embodiment, the design may be modified to remove the guide block and spring. In this way, the materials contained in the device, the manufacturing and the overall cost of the device may be reduced. This example embodiment of the extendable device without the use of a guide block or spring is described in reference to FIGS. 4 and 5.

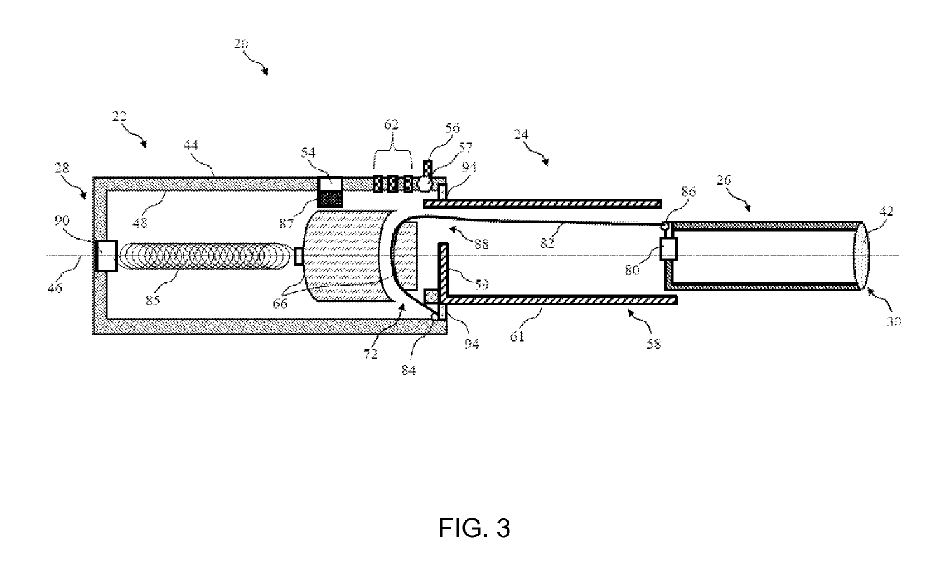

FIG. 1 shows a simplified cross-sectional view of a paint applicator 20 in accordance with a example embodiment of the invention. The paint applicator 20 includes a first handle section 22, a second handle section 24, an implement section 26, and a paint roller 42. The second handle section 24 can telescope within the first handle section 22, and the implement section 26 can telescope within the second handle section 24 such that the implement section 26 and second handle section 24 can move from a retracted position, shown in FIG. 1, to an extended position, shown in FIG. 3. The paint applicator 20 includes a proximal end 28 and a distal end 30.

In some example embodiments, the first handle section 22 includes an outer cylinder 44. The outer cylinder 44 has a first inner surface 48 and can be a tubular member that allows for another member to be slidable within it. The outer cylinder 44 may be manufactured from any material that is durable, such as polyethylene, polypropylene, nylon, fiberglass, aluminum, steel, etc. While an outer cylinder 44 having a circular cross section is disclosed herein, it is clear that other cross sectional shapes, such as rectangular, oval, triangular, etc. are within the scope of this disclosure.

In some example embodiments, the second handle section 24 includes an inner cylinder 58 with a second inner surface 59 and an outer surface 61 that is disposed within and slidable relative to the outer cylinder 44. The inner cylinder 58 can also be a tubular member that allows for another member to be slidable within its hollow core. The inner cylinder 58 can be manufactured from any material that is durable, such as polyethylene or polypropylene. While an inner cylinder 58 having a circular cross section is disclosed herein, it is clear that other cross sectional shapes, such as rectangular, oval, triangular, etc. are within the scope of this disclosure. Although it is shown in this example that the outer cylinder 44 and the inner cylinder 58 have similar shape of cross sections, this is not a limitation for the invention to function properly. It is possible to combine circular and/or other shapes of outer cylinder 44 with inner cylinder 58.

In order to prevent outer cylinder 44 and inner cylinder 58 from disengaging from one another, outward end crimps 92 may be added to the proximal end of inner cylinder 58, and inward end crimps 94 are added to the distal end of outer cylinder 44. Thus even if inner cylinder 58 is extended to its full length, it does not disengage from outer cylinder 44. Outward end crimps 92 and inward end crimps 94 may extend around the full perimeter, or around a partial perimeter of the respective cylinders, as long as both sets of crimps 92 and 94 align in operation to prevent disengagement.

Within outer cylinder 44, a guide block 66 may be affixed to a spring 85. First end of spring 85 is attached at the proximal end of the first inner surface 48, and a second end of spring 85 being attached at the proximal end of the guide block 66. The spring 85 can bias the paint applicator 20 in either the extended or retracted position, depending on user preference or application.

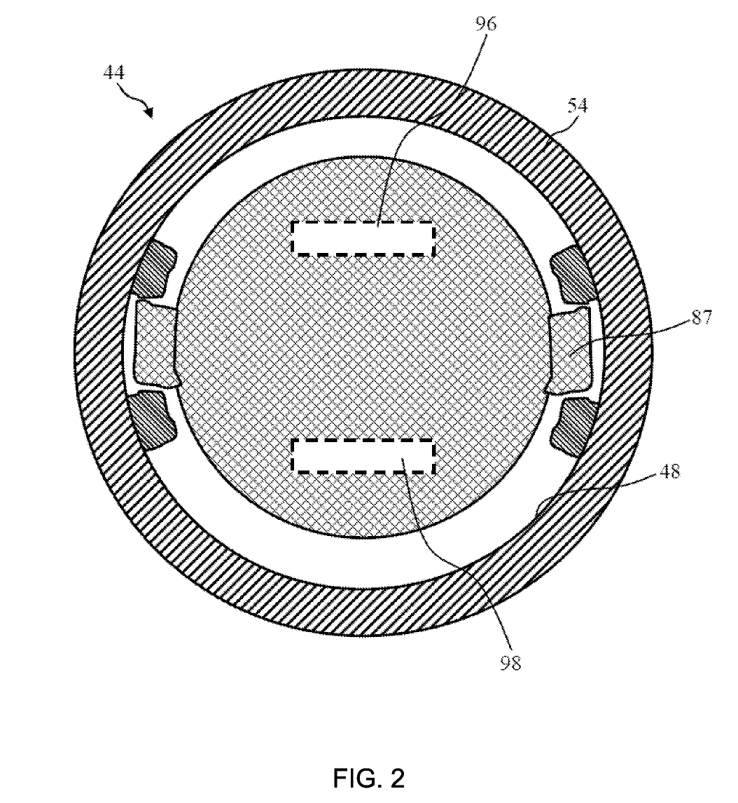

Guide block 66 may be of a shape designed to fit the first inner surface 48, and run along the length of the first inner surface 48, using for example a tongue and groove type of system as shown in FIG. 2, where handle 87 of guide block 66 compliments the first inner surface 48. In a second example, a gear-like system is used, where the first inner surface 48 compliments guide block 66 via a ridged or toothed design (not shown).

In some example embodiments, guide block 66 may have a curved channel 76 formed therein that defines a pushing surface 70. A first portion of the curved channel 76 is defined where the pushing surface 70 is opposite the pulling surface. A second portion of the curved channel 76 is defined where the pulling surface 72 is opposite from the outer cylinder 44. In this example, the curved channel 76 has a rectangular cross section, as shown in FIG. 2 by entrance 96 and exit 98 in guide block 66.

A single locking pin 56 is located on outer surface 61 at locking hole 54, and near the proximal end of inner cylinder 58. Pin spring 57 urges locking pin 56 upward and outward toward first inner surface 48. A plurality of receiver holes 62 is disposed toward the distal end of outer cylinder 44 to accommodate locking pin 56. To move the outer cylinder 44 relative to the inner cylinder 58, the user depresses locking pin 56 at locking hole 54, slides inner cylinder 58 within outer cylinder 44, and resets locking pin 56 in a new receiver hole 62. Other alternatives to spring-locking mechanisms may be used to achieve similar results.

Additionally, an alternative to using pins to secure guide block 66 and spring 85 is the use of an external camming system, such as that described in Black Diamond's patent U.S. Pat. No. 5,478,117. The camming system uses a lever arm that is “flicked” open, allowing the pole to be adjusted to the desired length, and then the lever arm is closed to lock the desired length into place. The technology uses a low profile clamp disposed about the outer cylinder section to squeeze the outer cylinder and secure the cylinders in a relative fixed position. The clamp includes a lever arm pivotally attached which pivots between a closed position, in which at least a portion of the lever arm rests against the outer cylinder section to cause it to grip the inner cylinder section, and an open position, in which the lever arm is pivoted away from the cylinder sections to release the grip by the outer cylinder section. The lever arm includes a camming knuckle which, when the lever arm is pivoted to the closed position, contacts and applies a force to the camming surface of one side edge preventing slippage.

Furthermore, other methods could utilize screws that can be rotated into threaded receiver holes to lock the inner cylinder 58 within the outer cylinder 44.

Specifications for spring 85 may depend on the size of paint applicator 20 and strength of material. The proximal end of outer cylinder 44 must be sufficiently strong to bear the compressed stored force of spring 85, and the locking pin 56 must be sufficiently strong when engaged at each receiver hole 62 to bear the stored force of spring 85 in various states of compression. Some designs may require additional locking pins to compensate for the spring load, for example, a second locking pin could be located near the proximal end of inner cylinder 58, but 180 degrees from locking pin 56 on outer surface 61.

In some example embodiments, an optional damper 90 may be affixed to the spring 85. The distal end of damper 90 is affixed to the proximal end of spring 85. The proximal end of damper 90 is affixed to the first inner surface 48 at the proximal end of outer cylinder 44 along the central axis 46. The damper used should be lightweight and capable of stabilizing, controlling, and absorbing the force of spring 85.

The guide block 66 may have an outer cross section similar to that of the first inner surface 48. The guide block 66 can include material with a reduced coefficient of friction such that the guide block can slide easily within the outer cylinder. Polymers such as Delrin® have been found to be acceptable. In this example, the guide block 66 positions the inner cylinder 58 within the outer cylinder 44 such that the inner cylinder 58 does not contact or wear against the first inner surface 48. The guide block 66 can be manufactured in two pieces, with a portion of the curved channel 76 milled out of both halves, or the entire curved channel 76 milled out of one of the pieces. The pieces can then be mated.

Slidably disposed within the hollow core of the inner cylinder 58 is the implement section 26. Affixed to the proximal end of the implement section 26 is a mounting block 80. The mounting block 80 generally can have a cross-section similar to the hollow core of the inner cylinder 58 such that the mounting block 80 can slide smoothly within the inner cylinder 58.

An advancement strip 82 may be affixed to the distal end of the first inner surface 48 at its first endpoint 84. The advancement strip 82 is disposed along the first inner surface 48 from the distal end towards the proximal end. It then enters through the second portion of the curved channel 76 at the pulling surface 72 and travels through the curved channel 76. The advancement strip 82 then enters through an opening 88 along the bottom surface of the proximal end of inner cylinder 58 and travels along the second inner surface 59 towards the distal end of inner cylinder 58. The advancement strip 82 is affixed on its second endpoint 86 to the mounting block 80. The advancement strip 82 can be affixed on its endpoints 84 and 86 by riveting, bonding, screwing, or other ways known in the art.

Additionally, a channel in the first inner surface 48 may be carved and may be lined with antifriction coating along the path of advancement strip 82 as it travels from the first inner surface 48, through the curved channel 76, and into second inner surface 59 to allow advancement strip 82 to glide easily and travel smoothly. In an alternate example, advancement strip 82 can be contained in a round or flat tube in order to provide best friction reduction and movement as it travels from between its endpoints 84 and 86. The tube should be flexible and lightweight, such as rubber, plastic, Polyvinyl Chloride (“PVC”), or nylon.

The advancement strip 82 performs the dual function of both pulling and pushing the implement section 26 through the inner cylinder 58. Thus, the advancement strip 82 should be flexible along its length such that it can curve and slide through the curved channel. The advancement strip 82 must be strong enough to pull the mounting block 80 from the extended position to the retracted position. However, the advancement strip 82 should be resistant to buckling such that it can push the mounting block 80 through the hollow core of the inner cylinder 58 from the retracted position to the extended position.

It has been found that strips made from spring steel such as those used in retractable tape measures has proven effective. A strip such as this can be arched along its length to provide strength against buckling. However, such a strip is also able to flatten out upon entry into the curved channel such that it can easily bend and slide through the curved channel 76. Other strips that can both push and pull and are also resistant to buckling, such as push-pull chains, can also easily be used. In methods to reduce friction, the curved channel 76 can be lined with a material with a reduced coefficient of friction, such as Delrin® or the like. Further, the advancement strip 82 can also be covered with an anti-friction coating.

In use, the paint applicator 20 may be used in the first position as shown in FIG. 1. However, if the user needs to paint an area that cannot be reached with the paint applicator 20 in the first position, the paint applicator 20 may be placed in the second position as seen in FIG. 3 such that the paint roller 42 is extended an additional distance.

To extend paint applicator 20 and adjust to the user's preferable length, the user can push and pass the locking pin 56 from the receiver holes 62 to allow relative motion between the inner cylinder 58 and the outer cylinder 44. The user can push the second handle section 24 distally away from the first handle section 22. The inner cylinder 58 and guide block 66 is pushed distally relative to the outer cylinder 44. As the guide block 66 is moved towards the distal end of the outer cylinder 44, the advancement strip 82 is forced through the curved channel 76 and is pushed through the opening 88 at the bottom surface of the proximal end of inner cylinder 58 and forced distally away from the user. Due to its resistance to buckling, the advancement strip 82 pushes the implement section 26 distally through the inner cylinder 58 as it moves along the second inner surface 59.

While the second handle section 24 is being moved relative to the first handle section 22, the distance between the first endpoint 84 of the advancement strip 82 and the pushing surface 70 decreases at the same rate the distance between the pushing surface 70 and the second endpoint 86 of the advancement strip 82 increases. Thus, for every unit of distance the second handle section 24 is moved relative to the first handle section 22, the implement section 26 is moved one unit of distance relative to the second handle section 24 and two units of distance relative to the first handle section 22.

To retract paint applicator 20, the user may simply push the locking pin 56 from the receiver holes 62 and pulls the second handle 24 back toward the first handle 22. As the guide block 66 is pulled proximally, the advancement strip 82 is pulled tight against the pulling surface 72, and forced to slide through the curved channel 76 thus drawing the implement section 26 proximally relative to the second handle section 24.

In some example embodiments, the guide block 66 and spring 85 may be removed from the outer cylinder 44 shown in FIGS. 4 and 5. If the user needs to paint an area that cannot be reached with the paint applicator 20 in the first position as shown in FIG. 4, the paint applicator 20 can be placed in the second position as seen in FIG. 5 4 such that the paint roller 42 is extended an additional distance.

A locking pin 56, a pin spring 57, and receiver holes 62 is located on outer surface 61, and near the proximal end of inner cylinder 58. Pin spring 57 urges locking pin 56 upward and outward toward first inner surface 48. A plurality of receiver holes 62 is disposed toward the distal end of outer cylinder 44 to accommodate locking pin 56. To move the outer cylinder 44 relative to the inner cylinder 58, the user depresses locking pin 56, slides inner cylinder 58 within outer cylinder 44, and resets locking pin 56 in a new receiver hole 62. Other alternatives to spring locking mechanisms may be used to achieve similar results.

A channel 95 in the first inner surface 48 may be carved and can be further lined with anti-friction coating along the path of advancement strip 82 as it travels from the first inner surface 48 and into second inner surface 59 via opening 88 to allow advancement strip 82 to glide easily and travel smoothly from endpoints 84 to 86.

To extend paint applicator 20 and adjust to the user's preferable length, the user can push and pass locking pin 56 from the receiver holes 62 to allow relative motion between the inner cylinder 58 and the outer cylinder 44. The user can push the second handle section 24 distally away from the first handle section 22. The inner cylinder 58 is pushed distally relative to the outer cylinder 44, and the advancement strip 82 travels through the carved channel 95, through the opening 88 at the bottom surface of the proximal end of inner cylinder 58 and forced distally away from the user. Due to its resistance to buckling, the advancement strip 82 pushes the implement section 26 distally through the inner cylinder 58 as it moves along the second inner surface 59.

To retract paint applicator 20, the user may simply push the locking pin 56 from the receiver holes 62 and pulls the second handle 24 back towards the first handle 22. As second handle 24 is pulled back, the advancement strip 82 is pulled tight, and forced to slide through the carved channel 95 thus drawing the implement section 26 proximally relative to the second handle section 24.

From the foregoing, one of ordinary skill in the art will appreciate that the present disclosure sets forth a paint roller that can easily extend to reach remote areas. However, one of ordinary skill in the art could readily apply the novel teachings of this disclosure to any number of situations in which an extendable device is desirable. This includes, but is not limited to, glass cleaners, booms, brooms, camera tripods, garden tools, medical devices such as IV poles, adjustable gurneys, etc. As such, the teachings of this disclosure shall not be considered to be limited to the specific examples disclosed herein, but to include all applications within the spirit and scope of the invention.

Following from the above description and invention summaries, it should be apparent to those of ordinary skill in the art that, while the methods and apparatuses herein described constitute exemplary embodiments of the present invention, it is to be understood that the inventions contained herein are not limited to the above precise embodiment and that changes may be made without departing from the scope of the invention. Likewise, it is to be understood that it is not necessary to meet any or all of the identified advantages or objects of the invention disclosed herein in order to fall within the scope of the invention, since inherent and/or unforeseen advantages of the present invention may exist even though they may not have been explicitly discussed herein.

What is claimed is:

1. An extendable device, comprising:
a first handle section having a distal end and a proximal end;
a second handle section having a distal end and a proximal end, the second handle slideably disposed within the first handle section;
an implement section having a distal end and a proximal end, the implement section slideably disposed within the second handle section;
an advancement strip having a first end and second end, the first end of the advancement strip being coupled to the proximal end of the implement section, and the second end of the advancement strip being coupled to the first handle section near the distal end of the first handle section;
a guide block having a distal end, a proximal end and a curved channel for receiving the advancement strip, the guide block slideably disposed within the first handle section; and
a spring having a distal end and a proximal end, the distal end of the spring being coupled to the proximal end of the guide block, and the proximal end of the spring being coupled to the proximal end of the first handle section;
wherein the advancement strip is adapted to push and/or pull at least one of the second handle section and the implement section relative to the first handle section.

2. The device of claim 1, further comprising:
a paint roller rotatably coupled to the distal end of the implement section.

3. The device of claim 1, further comprising:
a movement restriction mechanism adapted to restrict relative movement between the first handle section and the second handle section.

4. The device of claim 3,
wherein the movement restriction mechanism comprises a locking pin; and
wherein the first handle section includes one or more receiver holes to receive the locking pin.

5. The device of claim 4, wherein the locking pin is biased toward the first handle section by a pin spring.

6. The device of claim 1, wherein the spring is biased toward an extended position.

7. The device of claim 1, wherein the spring is biased toward a retracted position.

8. The device of claim 1, further comprising a damper coupled between the proximal end of the spring and the proximal end of the first handle section.

9. The device of claim 1, wherein the implement section includes a mounting block that is slidable within the second handle section.

10. The device of claim 1, wherein the advancement strip is constructed of spring steel, a push-pull chain, or plastic.

11. The device of claim 1, further comprising:
one or more crimps adapted to restrict disengagement of the first handle section from the second handle section, each of the one or more crimps being coupled to one of the first handle section and the second handle section.

12. An extendable device, comprising:
a first handle section having a distal end and a proximal end;
a second handle section having a distal end and a proximal end, the second handle slideably disposed within the first handle section;
an implement section having a distal end and a proximal end, the implement section slideably disposed within the second handle section;
an advancement strip having a first end and second end, the first end of the advancement strip being coupled to the proximal end of the implement section, and the second end of the advancement strip being coupled to the first handle section near the distal end of the first handle section; and
an advancement strip channel adapted to guide the advancement strip;
wherein the advancement strip is adapted to push and/or pull at least one of the second handle section and the implement section relative to the first handle section.

13. The device of claim 12, further comprising:
a paint roller rotatably coupled to the distal end of the implement section.

14. The device of claim 12, further comprising:
a movement restriction mechanism adapted to restrict relative movement between the first handle section and the second handle section.

15. The device of claim 14,
wherein the movement restriction mechanism comprises a locking pin; and
wherein the first handle section includes one or more receiver holes to receive the locking pin.

16. The device of claim 12, wherein the locking pin is biased toward the first handle section by a pin spring.

17. The device of claim 12, wherein the movement restriction mechanism comprises a camming mechanism.

18. The device of claim 12, wherein the advancement strip channel is coupled to an interior surface of the first handle section.

19. An extendable paint applicator, comprising:
an outer cylinder having a first end, a second end and at least one inward crimp;
an inner cylinder having a third end, a fourth end and at least one outward crimp, the inner cylinder slidably disposed within the outer cylinder;
an implement section having a fifth end, a sixth end and a mounting block;
an advancement strip having a seventh end and an eighth end, the seventh end being coupled to the mounting block, and the eighth end being coupled to an interior surface of the outer cylinder; and
a guide mechanism having a channel for guiding the advancement strip;
wherein the advancement strip is adapted to push and/or pull at least one of the inner cylinder and the implement section relative to the outer cylinder.

20. The extendable paint applicator of claim 19, further comprising:
a movement restriction mechanism including a locking pin and one or more receiver holes for receiving the locking pin and at least temporarily restricting relative movement between the outer cylinder and the inner cylinder.
